(19) United States
(12) Patent Application Publication
(10) Pub. No.: US 2022/0267192 A1
(43) Pub. Date: Aug. 25, 2022

(54) METHODS FOR PRODUCING A HOLLOW-CORE FIBER AND FOR PRODUCING A PREFORM FOR A HOLLOW-CORE FIBER

(71) Applicant: HERAEUS QUARZGLAS GMBH & CO. KG, Hanau (DE)

(72) Inventors: Manuel Rosenberger, Hanau (DE); Martin Trommer, Hanau (DE); Steffen Weimann, Hanau (DE); Michael Hünermann, Hanau (DE); Kay Schuster, Hanau (DE); Yusuf Tansel, Hanau (DE)

(21) Appl. No.: 17/624,919

(22) PCT Filed: Jul. 15, 2020
(86) PCT No.: PCT/EP2020/070000

§ 371 Date: Jan. 5, 2022

(30) Foreign Application Priority Data
Jul. 17, 2019 (EP) 19186776.1

(51) Int. Cl. C03B 37/027; C03B 37/012

(52) U.S. Cl. CPC C03B 37/02781; C03B 37/0122; C03B 37/0124; C03B 2203/16; C03B 2203/42

(57) ABSTRACT

Methods are known for producing an anti-resonant hollow-core fiber which has a hollow core extending along a fiber longitudinal axis and an inner jacket region that surrounds the hollow core, said jacket region comprising multiple anti-resonant elements. The known methods have the steps of: providing a cladding tube that has a cladding tube inner bore and a cladding tube longitudinal axis along which a cladding tube wall extends that is delimited by an interior and an exterior; providing a number of tubular anti-resonant element preforms; arranging the anti-resonant element preforms at target positions of the interior of the cladding tube wall, thereby forming a primary preform which has a hollow core region and an inner jacket region; and elongating the primary preform in order to form the hollow-core fiber or further processing the primary preform in order to form a secondary preform. The aim of the invention is to achieve a high degree of precision and an exact positioning of the anti-resonant elements in a sufficiently stable and reproducible manner on the basis of the aforementioned methods. This is achieved in that a cladding tube is provided with an outer diameter ranging from 90 to 250 mm and a length of at least 1 m; tubular structural elements are provided, at least some of which have a wall thickness ranging from 0.2 to 2 mm and a length of at least 1 m; and the structural elements are arranged in the cladding tube inner bore while the cladding tube longitudinal axis is vertically oriented, the upper end face of each structural element being positioned at the target position.

### TECHNICAL BACKGROUND

The invention relates to a method for producing an anti-resonant hollow-core fiber comprising a hollow core extending along a longitudinal axis of the fiber and a sheath region surrounding the hollow core, which sheath region comprises several anti-resonance elements, comprising the method steps of:
(a) providing a cladding tube comprising an inner bore of the cladding tube and a longitudinal axis of the cladding tube, along which a cladding tube wall delimited by an inner side and an outer side extends,
(b) providing a number of anti-resonance element preforms composed of several nested tubular structural elements and comprising an ARE outer tube and an ARE inner tube inserted therein, wherein the structural elements have a structural elements longitudinal axis,
(c) arranging the anti-resonance element preforms at desired positions on the inner side of the cladding tube wall to form a primary preform for the hollow-core fiber, which comprises a hollow core region and an inner sheath region, and
(d) elongating the primary preform to form the hollow-core fiber or further processing the primary preform to form a secondary preform from which the hollow-core fiber is drawn, wherein the further processing comprises a single or repeated performance of one or more of the following hot-forming processes:
   (i) elongation,
   (ii) collapse,
   (iii) collapse and simultaneous elongation,
   (iv) collapse of additional sheath material,
   (v) collapse of additional sheath material and subsequent elongation,
   (vi) collapse of additional sheath material and simultaneous elongation,

The invention also relates to a method for producing a preform for an anti-resonant hollow-core fiber comprising a hollow core extending along a longitudinal axis of the fiber and a sheath region surrounding the hollow core, which sheath region comprises several anti-resonance elements, comprising the method steps of:
(a) providing a cladding tube comprising an inner bore of the cladding tube and a longitudinal axis of the cladding tube, along which a cladding tube wall delimited by an inner side and an outer side extends,
(b) providing a number of anti-resonance element preforms composed of several nested tubular structural elements and comprising an ARE outer tube and an ARE inner tube inserted therein, wherein the structural elements have a structural elements longitudinal axis,
(c) arranging the anti-resonance element preforms at desired positions on the inner side of the cladding tube wall to form a primary preform for the hollow-core fiber, which comprises a hollow core region and an inner sheath region, and
(d) optionally further processing the primary preform to form a secondary preform for the hollow-core fiber, wherein the further processing comprises a single or repeated performance of one or more of the following hot-forming processes:
   (i) elongation,
   (ii) collapse,
   (iii) collapse and simultaneous elongation,
   (iv) collapse of additional sheath material,
   (v) collapse of additional sheath material and subsequent elongation,
   (vi) collapse of additional sheath material and simultaneous elongation.

Conventional single-mode optical fibers made of solid material have a core region made of glass, which is surrounded by a sheath region made of glass with a lower refractive index. Light guidance is based thereby on total reflection between the core region and the sheath region. However, the interactions of the guided light with the solid material are associated with an increased latency in data transmission and relatively low damage thresholds with respect to high-energy radiation.

These disadvantages are prevented or reduced by “hollow-core fibers” in which the core comprises an evacuated cavity filled with gas or liquid. In hollow-core fibers, the interaction of the light with the glass is less than in solid-core fibers. The refractive index of the core is less than that of the sheath so that light guidance by total reflection is not possible and the light would normally escape from the core into the sheath. As a function of the physical mechanism of the light guidance, hollow-core fibers are divided into “photonic bandgap fibers” and “anti-resonance reflection fibers.”

In the case of “photonic bandgap fibers,” the hollow core region is surrounded by a sheath in which small hollow channels are arranged periodically. On the basis of semiconductor technology, the periodic structure of the hollow channels in the sheath brings about the effect referred to as the “photonic bandgap,” according to which light of certain wavelength ranges scattered at the sheath structures can constructively interfere due to Bragg reflection in the central cavity and cannot propagate transversely in the sheath.

In the embodiment of the hollow-core fiber referred to as “anti-resonant hollow-core fiber” (ARHCF), the hollow core region is surrounded by an inner sheath region in which so-called “anti-resonant elements” (or “anti-resonance elements,” “AREs” for short) are arranged. The walls of the anti-resonance elements evenly distributed around the hollow core can act as Fabry-Perot cavities operated in anti-resonance, which reflect the incident light and guide it through the fiber core.

This fiber technology promises a low optical attenuation, a very broad transmission spectrum (even in the UV or IR wavelength ranges), and a low latency in data transmission.

Potential applications of the hollow-core fibers lie in the fields of data transmission, high-power beam guidance, for example for material processing, modal filtering, non-linear optics, in particular for super-continuum generation, from the ultraviolet to infrared wavelength range.

### PRIOR ART

A disadvantage of anti-resonant hollow-core fibers is that higher-order modes are not necessarily suppressed so that they are often not exclusively single-mode over long transmission lengths and the quality of the output beam deteriorates.

In the paper by Francesco Poletti “Nested antiresonant nodeless hollow core fiber,” Optics Express, vol. 22, no. 20 (2014), DOI: 10.1364/OE 22.023807, a fiber design is proposed, with which anti-resonance elements are not designed as a simple singular structural element but are composed of several nested structural elements. The nested anti-resonance elements are designed such that higher-order core modes, but not the fundamental core mode, are phase-matched to the sheath modes and are suppressed. As a result, the propagation of the fundamental core mode is always ensured, and the hollow-core fiber can be effectively single-mode over a limited wavelength range.

Effective mode suppression depends on the center wavelength of the transmitted light and on the structural parameters of the fiber design, such as the radius of the hollow core and the difference in the diameters of nested ring structures in the anti-resonance elements.

EP 3 136 143 A1 discloses an anti-resonant hollow-core fiber (referred to therein as “hollow-core fiber of non-bandgap type”), in which the core can conduct further modes in addition to the fundamental mode. For this purpose, it is surrounded by an inner sheath having “non-resonant elements,” which provide a phase-matching of anti-resonant modes with the higher modes. The hollow-core fiber is produced according to what is known as a “stack-and-draw technique” by arranging the starting elements to form an axially parallel ensemble and fixing them to form a preform and then elongating the preform. In this case, a cladding tube with a hexagonal inner cross-section is used, and six so-called “ARE preforms” (anti-resonance element preforms) are fixed in the inner edges of the cladding tube. This preform is drawn in two stages to form a hollow-core fiber.

WO 2018/169487 A1 discloses a method for producing a preform for anti-resonant hollow-core fibers, in which a first sheath region comprises a plurality of rods and a second sheath region comprises a plurality of tubes surrounded by an outer cladding tube. Rods, tubes, and cladding tube are joined to form a preform by means of the “stack and draw” technique. Before the preform is elongated, the preform end is sealed, which is done by applying a sealing compound. For example, a UV adhesive is used as the sealing compound.

### Technical Object

Anti-resonant hollow-core fibers, and in particular those with nested structural elements, have complex internal geometries, which makes it difficult for them to be produced exactly and reproducibly. This applies all the more because, if the resonance or anti-resonance conditions are to be maintained, even small variations in dimensions in the order of magnitude of the operating wavelength of the light to be guided cannot be tolerated. Deviations from the desired geometry can be caused by the configuration of the fiber preform, and they can also occur through undesired deformations that are not true to scale in the fiber-drawing process.

In the known “stack and draw” technique, many elements are to be joined together with positional accuracy. For example, in order to produce the hollow-core fiber known from the aforementioned paper in the “NANF” design, six anti-resonance element preforms, each consisting of an anti-resonance element outer tube (ARE outer tube, for short) and an anti-resonance element inner tube welded on one side to the inner sheath surface of the ARE outer tube (ARE inner tube, for short) must be attached to the inner side of a cladding tube.

In order to achieve low attenuation values and broad transmission ranges, the azimuthal position of the anti-resonance elements within the cladding tube is also important in addition to a uniform wall thickness of the walls of the anti-resonance elements. This cannot be easily achieved with the “stack and draw” technique. The object of the invention is to specify a method for the cost-effective production of an anti-resonant hollow-core fiber that avoids the limitations of conventional production methods.

In particular, it is the object of the invention to provide a method for producing an anti-resonant hollow-core fiber and a preform for anti-resonant hollow-core fibers, with which a high precision of the structural elements and an exact positioning of the anti-resonance elements in the fiber can be reproducibly achieved in a sufficiently stable and reproducible manner.

Moreover, disadvantages of the classic “stack and draw” technique, with which the required structural accuracies, in particular a uniform wall thickness of the anti-resonance elements and exact positioning at predetermined azimuthal positions, is not easy to achieve, are to be avoided if at all possible.

### SUMMARY OF THE INVENTION

With regard to the method for producing the anti-resonant hollow-core fiber, this object is achieved according to the invention starting from a method of the genus mentioned at the outset in that a cladding tube having an outer diameter in the range of 90 and 250 mm and a length of at least 1 m is provided, and that tubular structural elements are provided, at least a portion of which has a wall thickness in the range of 0.2 and 2 mm and a length of at least 1 m, and that the structural elements are arranged in the inner bore of the cladding tube according to method step (c) with a vertically oriented longitudinal axis of the cladding tube, wherein the structural elements are each positioned at the desired position at their upper face end.

The starting point for producing the anti-resonant hollow-core fiber is a preform referred to herein also as a “primary preform.” It comprises a cladding tube in which or on which precursors or preforms for the shaping of anti-resonance elements are contained in the hollow-core fibers (referred to here as “anti-resonance elements” for short). The primary preform can be elongated to form the hollow-core fiber; however, as a rule, the primary preform is further processed to produce therefrom a preform referred to herein as a “secondary preform.” Optionally, the hollow-core fiber is produced by elongating the secondary preform. Alternatively, the primary preform or the secondary preform are surrounded by an overlay cylinder or several overlay cylinders to form a coaxial ensemble of components, and the coaxial ensemble is elongated directly to form the hollow-core fiber. The general term “preform” is understood here to mean that component or that coaxial ensemble of components from which the hollow-core fiber is ultimately drawn.

The addition of sheath material is accomplished, for example, by collapsing an overlay cylinder onto the primary preform. The coaxial arrangement of primary preform and overlay cylinder is elongated or is not elongated when collapsing the overlay cylinder. The anti-resonance element preforms here are changed in their shape or arrangement, or they are not changed in their shape or arrangement.

The accuracy of the positioning of the preforms in the cladding tube is improved in that tubular structural elements are provided, at least a portion of which has a wall thickness in the range of 0.2 and 2 mm, preferably a wall thickness in the range of 0.25 and 1 mm, and wherein a cladding tube with an outer diameter in the range of 90 and 250 mm, and preferably with an outer diameter in the range of 120 to 200 mm, is provided. These components each have a length of at least 1 m.

These are relatively large-volume structural elements for forming anti-resonance elements. This simplifies handling. In addition, with a vertical arrangement of cladding tube and structural elements, gravitational force supports the parallelity and vertical alignment of the longitudinal axes of the structural elements when the structural elements are each positioned and fixed at the desired position at their upper face end.

The positioning and fixing takes place, for example, by a structuring of the inner side of the cladding tube and/or by using a positioning template and/or by using an adhesive, such as a sealing and bonding compound containing SiO₂ particles.

It has proven to be advantageous if, before drawing the hollow-core fiber in accordance with method step (d), at least one of the face ends of the anti-resonance element preforms is sealed.

The preform used in the method according to the invention for the fiber-drawing process is characterized by a large outer diameter. Since, during fiber drawing, the existing absolute geometry errors are scaled down more strongly as the outer diameter of the preform increases, a more precise manufacturing of the hollow-core fiber is thus made possible in principle.

However, it has been found that a random increase in the outer diameter of the preform does not automatically lead to a more precise hollow-core fiber, but rather that the following measure helps to maintain a maximum relative geometry error of 3.5% in the wall thickness of the hollow-core fiber:

All anti-resonance element preforms or at least a portion form hollow channels and are generally open on both sides. The free inner diameter of the hollow channels is small and typically lies in the range of a few millimeters in the preform. In the hot-forming process, the preform is heated from the outside so that a radial temperature gradient is established in the preform volume. Said gradient is, under otherwise identical process conditions, the larger the thicker the preform is. There is the risk of the hollow channels shrinking differently as a result of the surface tension and as a function of the local temperature. This risk is all the greater, the greater the radial temperature gradient is and the thicker the preform is. However, the temperature gradient has no significant effects on the central hollow core. In order to address this effect in the relatively thick preforms according to the invention, the core region (hollow core) is left open in the fiber-drawing process with a vertical orientation of the longitudinal axes, but the otherwise open upper end is sealed in at least a portion of the anti-resonance element preforms.

As a result of sealing the upper end, each hollow channel has an initial gas volume. In the fiber-drawing process, the gas is heated and the pressure in the hollow channels is increased so that they expand starting from the bottom toward the top. Since the gas exchange in the narrow hollow channels is small and the hot gas cannot escape upward, the temperature difference between the lower and upper preform ends significantly determines the extent of expansion, namely substantially independently of the original hollow-channel diameter. However, this temperature difference is approximately the same for all hollow channels, regardless of their radial position, so that all hollow channels expand approximately to the same extent. As a result, the original distribution of the hollow-channel sizes in the thick preform is maintained even in the final hollow-core fiber.

This concept is also suitable for a reproducible and precise industrial-scale production method for anti-resonant hollow-core fibers. It is particularly suitable for precisely producing anti-resonant hollow-core fibers with nested anti-resonance elements of greatly differing inner diameters.

The accuracy of the positioning of the preforms on the inner sheath surface of the cladding tube is further improved by the inner side of the cladding tube and/or the outer side of the cladding tube and/or the inner side of the ARE outer tube and/or the outer side of the ARE outer tube being produced by machining, in particular by drilling, milling, grinding, honing, and/or polishing

In comparison to other known forming techniques, said machining techniques provide more precise and more delicate structures by using heat and pressure, and they avoid contamination of surfaces by molding tools, such as nozzles, presses, or fusion molds.

The machining preferably also comprises a structuring of the inner side of the cladding tube in the region of desired positions of the anti-resonance element preforms by providing it with a longitudinal structure extending in the direction of the longitudinal axis of the cladding tube. This longitudinal structure comprises, for example, longitudinal slots and/or longitudinal grooves in the inner wall of the cladding tube, which run in parallel to the longitudinal axis of the cladding tube and which are preferably produced by drilling, sawing, milling, cutting, or grinding.

The longitudinal structure extending in the direction of the longitudinal axis of the cladding tube serves as a positioning aid for the anti-resonance element preforms. It makes it easier for the anti-resonance element preforms to assume predetermined defined positions on the inner side of the cladding tube.

With a preferred method variant, the upper face ends of the structural elements are positioned at the desired position by means of a positioning template.

In this case, the positioning template is preferably used in the region of a cladding tube end face, preferably in the region of both cladding tube end faces.

The positioning template has, for example, a shaft projecting into the inner bore of the cladding tube, which shaft is provided with holding elements in the form of several holding arms pointing radially outward.

The structurally predetermined star-shaped arrangement of the holding elements facilitates the exact positioning of the anti-resonance element preforms at the respective desired positions and their fixing.

A procedure has also proven effective in which, when the hollow-core fiber is drawn in accordance with method step (d), several components of the preform made of quartz glass are heated together and softened, wherein the quartz glass of at least some of the preform components contains at least one dopant that lowers the viscosity of quartz glass.

Components of the preform comprise the cladding tube and the anti-resonance element preforms arranged therein, as well as additional sheath material that is provided, for example, in the form of one or more overlay cylinders and is collapsed onto the primary preform. Dopants used to lower the viscosity of quartz glass are preferably fluorine, chlorine, and/or hydroxyl groups.

Doping makes it possible to adapt the thermal expansion coefficients of adjacent preform components in order to avoid or reduce stresses. It can also be used to reduce the thermal stability of a component in favor of the stability of an adjacent component.

For example, it has proven to be advantageous if, at a measured temperature of 1250° C., the quartz glass of the cladding tube has a viscosity at least 0.5 dPa·s higher, preferably a viscosity at least 0.6 dPa·s higher, than the quartz glass of additionally applied sheath material (if the viscosity is given as a logarithmic value in dPa·s).

The geometric accuracy of the positioning of the preforms on the inner sheath surface of the cladding tube is further improved if the provision of the primary preform comprises arranging the anti-resonance element preforms at desired positions of the inner side of the cladding tube wall, wherein the arranging of the anti-resonance element preforms and/or the drawing of the hollow-core fiber in accordance with method step (d) comprises a fixing measure and/or a sealing measure using a sealing or bonding compound containing amorphous SiO₂ particles.

The sealing or bonding compound used for sealing or fixing contains amorphous SiO₂ particles, which are held, for example, in a dispersion liquid. This compound is applied between the surfaces to be bonded or sealed and is generally pasty during use. During drying at low temperature, the dispersion liquid is partially or completely removed and the compound solidified. The sealing or bonding compound, and in particular the solidified SiO₂-containing sealing or bonding compound obtained after drying, satisfies the requirements for fixing and compacting. The temperature required for drying is below 300° C., which facilitates compliance with the dimensional stability of the preform and avoids thermal impairments. Heating to higher temperatures around 800° C., for example during elongation of the preform to form the hollow-core fiber, results in further thermal solidification of the sealing or bonding compound, which is also suitable for forming opaque or transparent glass. This is done by sintering or vitrifying, wherein sintering to form opaque glass requires comparatively lower temperatures and/or short heating durations than vitrifying to complete transparency. The sealing or bonding compound can thus be completely compacted by heating and vitrified by heating in the hot-forming process. The sealing or bonding compound behaves like quartz glass; it becomes viscous and deformable.

In the hot-forming process, the sealing or bonding compound does not decompose and releases few impurities. It is thus characterized by thermal stability and purity in the hot-forming process and avoids deformations resulting from different thermal coefficients of expansion.

With regard to the production of the preform for the hollow-core fiber, the aforementioned technical object is achieved according to the invention starting from a method of the genus mentioned at the outset in that a cladding tube having an outer diameter in the range of 90 and 250 mm and a length of at least 1 m is provided, and that tubular structural elements are provided, at least a portion of which has a wall thickness in the range of 0.2 and 2 mm and a length of at least 1 m, and that the structural elements are arranged in the inner bore of the cladding tube in accordance with method step (c) with a vertically oriented longitudinal axis of the cladding tube, wherein the structural elements are each positioned at the desired position at their upper face end.

The preform is a starting point for the production of the anti-resonant hollow-core fiber. By elongating the primary preform, either the anti-resonant hollow-core fiber is drawn directly, or a different semi-finished product is first produced by further processing of the primary preform, which semi-finished product is also referred to herein as the “secondary preform” and from which semi-finished product the anti-resonant hollow-core fiber can be drawn.

In any case, the production of the preform comprises the installation and the connecting of anti-resonance element preforms to a cladding tube. The accuracy of the positioning of the preforms is improved in that both the cladding tube and the anti-resonance element preforms are comparatively large in volume and are long components, and are joined together with a vertically oriented longitudinal axis so that handling is simplified and the gravitational force contributes to exact positioning and to parallel vertical alignment of the structural element longitudinal axes since the structural elements are each positioned and fixed at the desired position at their upper face end.

### Definitions

Individual method steps and terms of the above description are additionally defined below. The definitions form part of the description of the invention. That which is expressed in the description is definitive in the event of a factual contradiction between one of the following definitions and the remaining description.

Anti-Resonance Elements

The anti-resonance elements may be simple or nested structural elements of the hollow-core fiber. They have at least two walls that, when viewed from the direction of the hollow core, have a negative curvature (convex) or do not have a curvature (planar, straight). They generally consist of a material that is transparent to the working light, for example glass, in particular doped or undoped SiO₂, a plastic, in particular a polymer, a composite material or crystalline material.

Anti-Resonance Element Preform/Anti-Resonance Element Precursor

What are referred to as anti-resonance element preforms are components or constituents of the preform that essentially become anti-resonance elements in the hollow-core fiber by simple elongation during the fiber-drawing process. Components or constituents of the preform that become anti-resonance element preforms only upon forming or that become anti-resonance elements directly are referred to as anti-resonance element precursors. The anti-resonance element preforms may be simple or nested components to which additional positioning aids can be fixed. They are originally present in the primary preform.

Nested anti-resonance element preforms form nested anti-resonance elements in the hollow-core fiber. They are composed of an outer tube and at least one further structural element that is arranged in the inner bore of the outer tube. The further structural element can be a further tube which abuts against the inner sheath surface of the outer tube. The outer tube is referred to as an “anti-resonance element outer tube” or an “ARE outer tube” for short, and the further tube is referred to as an “anti-resonance element inner tube” or an “ARE inner tube” for short, or also as a “nested ARE inner tube.”

In the case of multi-nested anti-resonance element preforms, at least one further structural element, for example a third tube abutting against the inner sheath surface of the nested ARE inner tube, can be arranged in the inner bore of the nested ARE inner tube. Where there are multi-nested anti-resonance element preforms, in order to distinguish between the multiple tubes that are arranged within the ARE outer tube, a distinction can optionally be made between “outer nested ARE inner tube” and “inner nested ARE inner tube.”

The term “cross-section” in conjunction with cylindrical anti-resonance element preforms and their cylindrical structural elements always refers to the cross-section perpendicular to the respective longitudinal axis of the cylinder, namely, unless otherwise indicated, the cross-section of the outer contour in tubular components (not the cross-section of the inner contour).

Further processing of the primary preform, in particular by hot-forming steps, can result in intermediate products, in which the original anti-resonance element preforms are present in a shape that has been modified in comparison to the original shape. The modified shape is also referred to herein as an anti-resonance element preform or as an anti-resonance element precursor.

Preform/Primary Preform/Secondary Preform/Core Preform (Cane)

The preform is the component from which the anti-resonant hollow-core fiber is drawn. It is a primary preform or a secondary preform produced by further processing of the primary preform. The primary preform can be present as an ensemble consisting of at least one cladding tube and preforms or precursors for anti-resonance elements that are loosely accommodated or firmly fixed therein. The further processing of the primary preform to form a secondary preform from which the hollow-core fiber is drawn can comprise a single or repeated performance of one or more of the following hot-forming processes:

(i) elongation,

(ii) collapse,

(iii) collapse and simultaneous elongation,

(iv) collapse of additional sheath material,

(v) collapse of additional sheath material and subsequent elongation,

(vi) collapse of additional sheath material and simultaneous elongation.

A preform obtained by collapsing and/or elongating a primary preform is referred to in the literature as a core preform (cane). Typically, it is overlaid with additional sheath material before or during drawing of the hollow-core fiber.

Elongating/Collapsing

During elongation, the primary preform is lengthened. The lengthening can take place without simultaneous collapse. Elongation can take place true to scale so that, for example, the shape and arrangement of components or constituents of the primary preform is reflected in the elongated end product. During elongation, however, the primary preform can also be drawn not true to scale and its geometry can be modified.

During collapse, an inner bore is narrowed or annular gaps between tubular components are closed or narrowed. Collapse is generally accompanied by elongation.

Hollow Core/Inner Sheath Region/Outer Sheath Region

The ensemble comprising at least one cladding tube and therein loosely accommodated or firmly fixed preforms or precursors for anti-resonance elements is also referred to herein as “primary preform.” The primary preform comprises the hollow core and a sheath region. This sheath region is also referred to as an “inner sheath region” if there is also an “outer sheath region” that has been produced, for example, by collapsing onto the ensemble, and if a distinction is to be made between said sheath regions. The terms “inner sheath region” and “outer sheath region” are also used for the corresponding regions in the hollow-core fiber or in intermediate products obtained by further processing of the primary preform.

The designation “inner side of the tube” is also used as a synonym for “inner sheath surface of the tube” and the designation “outer side of the tube” is also used as a synonym for “outer sheath surface of the tube.” The term “inner bore” in conjunction with a tube does not mean that the inner bore has been produced by a drilling process.

Machining

This refers to separating mechanical manufacturing methods for the separating processing of a workpiece, in particular turning, cutting, drilling, sawing, milling, and grinding. This machining creates a longitudinal structure extending in the direction of the longitudinal axis of the cladding tube, which serves as a positioning aid for the anti-resonance element preforms. The longitudinal structure is accessible from the inner side of the cladding tube; it can also extend through the entire cladding tube wall to the outer side.

Particle Size and Particle Size Distribution

Particle size and particle size distribution of the SiO₂ particles are characterized using the D₅₀ values. These values are taken from particle size distribution curves showing the cumulative volume of SiO₂ particles as a function of the particle size. The particle size distributions are often characterized on the basis of the respective D₁₀, D₅₀, and D₉₀ values. In this case, the D₁₀ value characterizes the particle size that is not achieved by 10% of the cumulative volume of the SiO₂ particles, and accordingly, the D₅₀ value and the D₉₀ value characterize the particle sizes that are not achieved by 50% and by 90%, respectively, of the cumulative volume of the SiO₂ particles. The particle size distribution is determined by scattered light and laser diffraction spectroscopy according to ISO 13320.

### EXEMPLARY EMBODIMENT

The invention is explained in more detail below with reference to an exemplary embodiment and a drawing. The following are shown in detail in schematic representation:

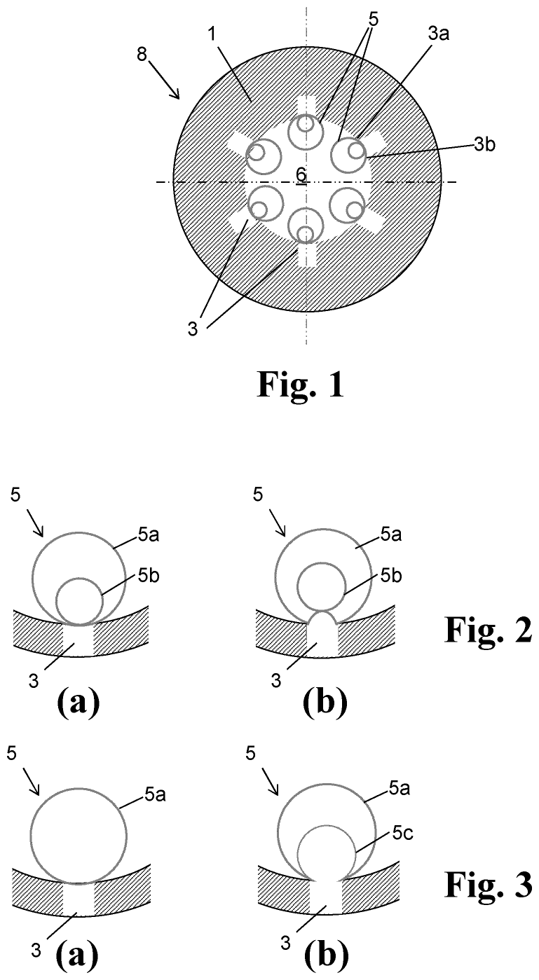

FIG. 1 a machined cladding tube provided with longitudinal grooves for use in the method according to the invention in a cross-sectional view,

FIG. 2 a detail of the longitudinal structure and anti-resonance element from FIG. 1 in an enlarged view, and

FIG. 3 a detail corresponding to FIG. 2 with another embodiment of the anti-resonance element.

Cladding tubes whose wall is provided with longitudinal grooves in the region of the inner sheath surface or whose wall has longitudinal slots are used. The longitudinal grooves or longitudinal slots are distributed uniformly around the inner circumference of the respective cladding tube in an odd or even symmetry, for example, and they serve to precisely position the anti-resonance element preforms at the desired positions in the quartz glass cladding tube.

FIG. 1 schematically shows the cross-section of a thick-walled quartz glass cladding tube 1 with longitudinal grooves 3 on the inner sheath surface. The inner wall of the cladding tube 1 is mechanically brought to the predetermined final dimension by drilling, grinding, and honing. Thereafter, the longitudinal grooves 3 are milled into the inner sheath surface at defined azimuthal positions at a uniform distance. The number of longitudinal grooves 3 corresponds to the number of anti-resonance element preforms 5 to be positioned; in the exemplary embodiment, there are six preforms 5. The longitudinal grooves 3 extend from one cladding tube end to the other so as to penetrate the end faces. Next, the cut edges (3a; 3b) are vitrified.

The cut width and the cut depth of the longitudinal grooves 3 are uniform and are each 2 mm. The anti-resonance element preforms 5 to be positioned thereon have a substantially round outer cross-section with a diameter of, for example, 7.4 mm. They lie on the two cut edges 3a; 3b of the longitudinal grooves 3 and project into the cladding tube inner bore 6. For fixing, the two ends of the anti-resonance element preforms 5 are adhered in the region of the cladding tube end faces using a sealing and bonding compound containing SiO₂. By means of a subsequent lengthening of this ensemble, the anti-resonance element preforms 5 are connected over their entire length to the cut edges 3a; 3b inside the cladding tube 1. By applying positive pressure in the inner bore 6 of the cladding tube 1, it can be checked whether the longitudinal grooves 3 are completely closed by the anti-resonance element preforms 5. The longitudinal grooves 3 thus serve as an exact positioning aid on which each anti-resonance element preform 5 can be precisely positioned and fixed.

Instead of the thick-walled cladding tube 1, a cladding tube with a smaller wall thickness can also first be equipped with the anti-resonance element preforms 5 and additional sheath material can be applied to the primary preform thus produced, in particular by overlaying with an overlay cylinder brought to final dimension by machining.

During elongation of the primary preform 8 to form the hollow-core fiber or to form another precursor of the hollow-core fiber, gas can be introduced into or withdrawn from the hollow channels that have formed in the longitudinal grooves 3 and the fused anti-resonance element preforms 5, in order to produce positive pressure or negative pressure in the hollow channels.

If required or desired, the radial position of the anti-resonance elements 5 in the inner bore 6 of the cladding tube can thus be modified and corrected, as outlined in FIG. 2. Sketch (a) shows an anti-resonance element preform 5 having an ARE outer tube 5a and a nested (ARE inner tube 5b in the starting position. Sketch (b) shows the outer tube wall, which is deformed by pressure and heat and which is inverted inward in regions, with the ARE inner tube 5b fixed to the inversion in a radial position that is modified in comparison to the starting position. Fiber designs which, in deviation from the classic “stack-and-draw technique,” even have non-hexagonal symmetry and in particular non-integral symmetry can thus also be realized.

By applying pressure in the hollow channels, it is also possible to “fold over” a wall section of an anti-resonance element preform 5 toward the inside of the anti-resonance element preform. FIG. 3(a) shows an anti-resonance element preform 5 with a simple outer tube 5a (without an additional nested ARE inner tube) in the starting position. Under the influence of heat and pressure, the wall section between the two contact lines is inflated inward. As shown in FIG. 3(b), a further glass membrane 5c with a negatively (convexly) curved surface thus arises within the outer tube 5a, which curved surface can replace a nested inner element (such as the ARE inner tube 5b).

The wall thickness of the individual structural elements 5a, 5b of the anti-resonance element preforms 5 is in the range of 0.2 and 2 mm, and the outer diameter of the sheath 1 is in the range of 90 and 250 mm. The length of the components is the same and is 1 m.

A small deflection of the longitudinal axes of the structural elements is achieved by the mass of the cladding tube and the comparatively large-volume, tubular and long structural elements, assisted by the positioning of the anti-resonance element preforms with vertically oriented longitudinal axis. A maximum angular deviation of 0.3 degrees was measured.

Table 1 shows dimensions of these components for an anti-resonant hollow-core fiber in which the wall thickness (WT) of the structural elements for the anti-resonance elements in the final fiber is 0.55 μm. The column “Fiber” specifies further dimensions of the hollow-core fibers to be produced:

TABLE 1

| | | | Preform | Preform |
|---|---|---|---|---|
| | | Fiber | OD 90 | OD 220 |
| WT = 0.55 μm | | (μm) | (mm) | (mm) |
| Cladding | OD | 230 | 90 | 250 |
| tube | ID | 98 | 38 | 107 |
| | OD/ID | 2.3 | | |
| ARE | OD | 29 | 11.3 | 31.5 |
| | ID | 27.9 | 10.9 | 30.3 |
| | WT | 0.55 | 0.22 | 0.60 |
| | ID/OD | 0.96 | 0.96 | 0.96 |
| | OD/ID | 1.04 | 1.04 | 1.04 |
| NE | OD | 8.8 | 3.4 | 9.6 |
| | ID | 7.7 | 3 | 8.4 |
| | WT | 0.55 | 0.22 | 0.60 |
| | ID/OD | 0.75 | 0.88 | 0.88 |
| | OD/ID | 1.33 | 1.14 | 1.14 |
| Core | D | 40 | 15.7 | 43.5 |
| d | d | 5.5 | 2.15 | 6.98 |

Here:
OD Outer diameter
ID Inner diameter
ARE: ARE outer tube 5a of the anti-resonance element preform
NE ARE inner tube 5b of the anti-resonance element preform
Core D Inner diameter of the hollow core
d Wall thickness

Table 2 shows the dimensions for an anti-resonant hollow-core fiber in which the wall thickness (WT) of the structural elements in the final fiber is 1.10 μm. The column “Fiber” specifies the dimensions of the hollow-core fibers to be produced. The short terms used in Table 1 and explained therein are used.

TABLE 2

| | | | Preform | Preform |
|---|---|---|---|---|
| | | Fiber | OD 90 | OD 220 |
| WT = 1.10 μm | | (μm) | (mm) | (mm) |
| Cladding | OD_{Sheath} | 230 | 90 | 250 |
| tube | ID_{Cane} | 98 | 38 | 107 |
| | OD/ID | 2.3 | | |
| ARE | OD | 29 | 11.3 | 31.5 |
| | ID | 26.8 | 10.5 | 29.1 |
| | WT | 1.10 | 0.43 | 1.20 |
| | ID/OD | 0.92 | 0.92 | 0.92 |
| | OD/ID | 1.08 | 1.08 | 1.08 |
| NE | OD | 8.8 | 3.4 | 9.6 |
| | ID | 6.6 | 2.6 | 7.2 |
| | WT | 1.10 | 0.43 | 1.20 |
| | ID/OD | 0.75 | 0.75 | 0.75 |
| | OD/ID | 1.33 | 1.33 | 1.33 |
| Core | D | 40 | 15.7 | 43.5 |
| d | d | 5.5 | 2.15 | 5.98 |
| | z/R | 0.90 | | |

1. Method for producing an anti-resonant hollow-core fiber comprising a hollow core extending along a longitudinal axis of the fiber and an inner sheath region surrounding the hollow core, which sheath region comprises several anti-resonance elements, comprising the method steps of:
(a) providing a cladding tube (1) comprising an inner bore (6) of the cladding tube and a longitudinal axis of the cladding tube, along which a cladding tube wall delimited by an inner side and an outer side extends,
(b) providing a number of anti-resonance element preforms (5) composed of several nested tubular structural elements and comprising an ARE outer tube (5a) and an ARE inner tube (5b) inserted therein, wherein the structural elements have a structural elements longitudinal axis,
(c) arranging the anti-resonance element preforms (5) at desired positions on the inner side of the cladding tube wall to form a primary preform (8) for the hollow-core fiber, which comprises a hollow core region and an inner sheath region, and
(d) elongating the primary preform (8) to form the hollow-core fiber or further processing the primary preform (8) to form a secondary preform from which the hollow-core fiber is drawn, wherein the further processing comprises a single or repeated performance of one or more of the following hot-forming processes:
(i) elongation,
(ii) collapse,
(iii) collapse and simultaneous elongation,
(iv) collapse of additional sheath material,
(v) collapse of additional sheath material and subsequent elongation,
(vi) collapse of additional sheath material and simultaneous elongation,
characterized in that a cladding tube (1) having an outer diameter in the range of 90 and 250 mm and a length of at least 1 m is provided, and that tubular structural elements (5a; 5b) are provided, at least a portion of which has a wall thickness in the range of 0.2 and 2 mm and a length of at least 1 m, and that the structural elements (5a; 5b) are arranged in the inner bore of the cladding tube in accordance with method step (c) with a vertically oriented longitudinal axis of the cladding tube, wherein the structural elements (5a; 5b) are each positioned at the desired position at their upper face end.

2. Method according to claim 1, characterized in that a cladding tube (1) having an outer diameter in the range of 120 to 200 mm is provided, and that tubular structural elements (5a; 5b) are provided, at least a portion of which has a wall thickness in the range of 0.25 and 1 mm.

3. Method according to claim 1 or 2, characterized in that at least one of the face ends of the anti-resonance element preforms (5) is sealed prior to drawing the hollow-core fiber in accordance with method step (d).

4. Method according to any of the preceding claims, characterized in that the inner side of the cladding tube and/or the outer side of the cladding tube and/or the inner side of the ARE outer tube and/or the outer side of the ARE outer tube is produced by machining, in particular by drilling, milling, grinding, honing, and/or polishing

5. Method according to any of the preceding claims, characterized in that the inner side of the cladding tube is provided with a longitudinal structure (3) extending in the direction of the longitudinal axis of the cladding tube by machining in the region of the desired positions.

6. Method according to any of the preceding claims, characterized in that the upper face ends of the structural elements (5a; 5b) are positioned at the desired position by means of a positioning template.

7. Method according to claim 6, characterized in that the positioning template is used in the region of a cladding tube end face, preferably in the region of both cladding tube end faces.

8. Method according to any of the preceding claims, characterized in that, when the hollow-core fiber is drawn in accordance with method step (d), several components of the preform (8) made of quartz glass are heated together and softened, wherein the quartz glass of at least some of the preform components contains at least one dopant that lowers the viscosity of quartz glass.

9. Method according to claim 8, characterized in that additional sheath material is collapsed in accordance with method step (d), and in that the quartz glass of the cladding tube (1) at a measured temperature of 1250° C. has a viscosity at least 0.5 dPa·s higher, preferably a viscosity at least 0.6 dPa·s higher, than the quartz glass of the additionally applied sheath material (if the viscosity is given as a logarithmic value in dPa·s).

10. Method according to any of the preceding claims, characterized in that the provision of the primary preform (8) comprises arranging the anti-resonance element preforms (5) at desired positions of the inner side of the cladding tube wall, wherein the arranging of the anti-resonance element preforms (5) and/or the drawing of the hollow-core fiber in accordance with method step (d) comprises a fixing measure and/or a sealing measure using a sealing or bonding compound containing amorphous SiO₂ particles.

11. Method for producing a preform for an anti-resonant hollow-core fiber comprising a hollow core extending along a longitudinal axis of the fiber and an inner sheath region surrounding the hollow core, which sheath region comprises several anti-resonance elements, comprising the method steps of:
(a) providing a cladding tube (1) comprising an inner bore of the cladding tube and a longitudinal axis of the cladding tube, along which a cladding tube wall delimited by an inner side and an outer side extends,
(b) providing a number of anti-resonance element preforms (5) composed of several nested tubular structural elements and comprising an ARE outer tube (5a) and an ARE inner tube (5b) inserted therein, wherein the structural elements have a structural elements longitudinal axis,
(c) arranging the anti-resonance element preforms at desired positions on the inner side of the cladding tube wall to form a primary preform (8) for the hollow-core fiber, which comprises a hollow core region and an inner sheath region, and
(d) optionally further processing the primary preform (8) to form a secondary preform for the hollow-core fiber, wherein the further processing comprises a single or repeated performance of one or more of the following hot-forming processes:
(i) elongation,
(ii) collapse,
(iii) collapse and simultaneous elongation,
(iv) collapse of additional sheath material,
(v) collapse of additional sheath material and subsequent elongation,
(vi) collapse of additional sheath material and simultaneous elongation,
characterized in that a cladding tube (1) having an outer diameter in the range of 90 and 250 mm and a length of at least 1 m is provided, and that tubular structural elements (5a; 5b) are provided, at least a portion of which has a wall thickness in the range of 0.2 and 2 mm and a length of at least 1 m, and that the structural elements (5a; 5b) are arranged in the inner bore of the cladding tube in accordance with method step (c) with a vertically oriented longitudinal axis of the cladding tube, wherein the structural elements (5a; 5b) are each positioned at the desired position at their upper face end.
